(19) United States
(12) Patent Application Publication
(10) Pub. No.: US 2026/0046366 A1
(43) Pub. Date: Feb. 12, 2026

(54) INSPECTION APPARATUS, IMAGE FORMING APPARATUS, AND DISPLAY APPARATUS

(71) Applicant: CANON KABUSHIKI KAISHA, Tokyo (JP)

(72) Inventor: HIRONOBU KONNO, Ibaraki (JP)

(21) Appl. No.: 19/287,902

(22) Filed: Aug. 1, 2025

(30) Foreign Application Priority Data
Aug. 8, 2024 (JP) 2024-133205
Jun. 13, 2025 (JP) 2025-099619

(51) Int. Cl. H04N 1/00

(52) U.S. Cl. CPC H04N 1/00461; H04N 1/00015; H04N 1/00469

(57) ABSTRACT

An inspection apparatus includes a reader configured to read a sheet on which an image has been formed, an inspector configured to inspect a read image that has been read by the reader, a display device configured to display a display screen including a first display region in which an entirety of the read image is displayable and a second display region in which a part of the read image is displayed in an enlarged manner, and a controller configured to control the display device, wherein the controller is configured to, display, in a case where there is a first abnormal image in the read image inspected by the inspector, the read image in the first display region.

### BACKGROUND

### Field of the Technology

The present disclosure relates to an inspection apparatus that performs a quality inspection of an image printed on a sheet, and an image forming system that includes such an inspection apparatus and an image forming apparatus.

### Description of the Related Art

An image forming apparatus generates a printed matter by printing an image on a sheet based on image data representing an image to be printed. An inspection apparatus inspects whether or not an image printed on a printed matter is an image formed as instructed by image data. In the inspection apparatus, the image data is set as reference image data, an image (read image) obtained by reading the image printed on the printed matter through use of a sensor such as a scanner is set as read image data, and the reference image data and the read image data are compared to each other. The printing inspection apparatus determines whether or not the image on the printed matter is an image formed as instructed by the image data based on the degree of agreement between the reference image data and the read image data.

In U.S. Pat. No. 11,094,048, there is described an inspection device that inspects whether or not a read image that has been read from a printed matter is normal. In a case where the read image is determined to have an abnormality, the inspection device displays an image (inspection result image) for showing an inspection result on a display unit. In the inspection result image, an image (abnormal image) of a portion determined to be abnormal in an inspection is displayed in an enlarged manner based on a user operation. In addition, a reference image serving as an inspection reference for comparison to the read image is displayed. In this manner, it is easy to recognize the abnormal image.

In a case in which the printed matter is a large-sized one, such as a long sheet, the display unit may only display a part of the inspection result image in a case where the inspection result image is displayed in an enlarged manner. In this case, the part of the inspection result image displayed on the display unit may not include the abnormal image. This results in difficulty in distinguishing a relationship between the inspection result image and the abnormal image, and hence a position of the abnormal image in the inspection result image becomes unclear.

### SUMMARY

An inspection apparatus according to at least one embodiment of the present disclosure includes a reader configured to read a sheet on which an image has been formed, an inspector configured to inspect a read image that has been read by the reader, a display device configured to display a display screen including a first display region in which an entirety of the read image is displayable and a second display region in which a part of the read image is displayed in an enlarged manner, and a controller configured to control the display device, wherein the controller is configured to, display, in a case where there is a first abnormal image in the read image inspected by the inspector, the read image in the first display region, and display the first abnormal image in an enlarged manner in the second display region, and set a first display state for the second display region in a case where the first abnormal image is displayed in the first display region, and set a second display state different from the first display state for the second display region in a case where the first abnormal image is not displayed in the first display region.

An image forming apparatus according to another embodiment of the present disclosure includes an image former configured to form an image on a sheet, and an inspection apparatus, the inspection apparatus comprising, a reader configured to read the sheet on which the image has been formed, an inspector configured to inspect a read image that has been read by the reader, a display device configured to display a display screen including a first display region in which an entirety of the read image is displayable and a second display region in which a part of the read image is displayed in an enlarged manner, and a controller configured to control the display device, wherein the controller is configured to, display, in a case where there is a first abnormal image in the read image inspected by the inspector, the read image in the first display region, and display the first abnormal image in an enlarged manner in the second display region, and set a first display state for the second display region in a case where the first abnormal image is displayed in the first display region, and set a second display state different from the first display state for the second display region in a case where the first abnormal image is not displayed in the first display region.

A display apparatus according to yet another embodiment of the present disclosure includes a display device configured to display a display screen including a first display region in which an entirety of a read image is displayable and a second display region in which a part of the read image is displayed in an enlarged manner, and a display controller configured to control the display device, wherein the display device is controlled to display, in a case where there is a first abnormal image in the read image, the read image in the first display region, and display the first abnormal image in an enlarged manner in the second display region, and wherein the second display region is set to a first display state in a case where the first abnormal image is displayed in the first display region, and the second display region is set to a second display state different from the first display state in a case where the first abnormal image is not displayed in the first display region.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of an image forming system.

FIG. 2 is an explanatory diagram of a configuration of a controller.

FIG. 3 is an explanatory diagram of a configuration of an inspection controller.

FIG. 4 is an exemplary view of an operation screen.

FIG. 5 is an exemplary view of an inspection setting screen.

FIG. 6 is an exemplary view of a password input screen.

FIG. 7 is an exemplary view of an administrator setting screen.

FIG. 8 is an exemplary view of an inspection result display screen.

FIG. 9 is an exemplary view of the inspection result display screen on which a partial image of an inspection result image is displayed in an enlarged manner.

FIG. 10 is an exemplary view of the inspection result display screen on which a partial image of the inspection result image is displayed in an enlarged manner.

FIG. 11 is an exemplary view of a state in which an enlarged image is not displayed.

FIG. 12 is an exemplary view of a case in which a message is displayed.

FIG. 13 is an explanatory diagram of a procedure for shifting between the inspection result display screens.

FIG. 14 is an explanatory diagram of the procedure for shifting between the inspection result display screens.

FIG. 15 is a processing flow chart for illustrating printing inspection processing.

FIG. 16 is a processing flow chart for illustrating processing for displaying the inspection result display screen.

FIG. 17 is an exemplary view of the inspection result display screen obtained in a case where a plurality of abnormal images is displayed in the partial image.

FIG. 18 is an exemplary view of the inspection result display screen obtained in a case where no abnormal image is displayed in the partial image.

### DESCRIPTION OF THE EMBODIMENTS

Now, an exemplary embodiment of the present disclosure is described with reference to the accompanying drawings. The embodiment described below does not limit the disclosure according to the appended claims, and not all combinations of features described in the embodiment are necessarily essential to solving means for the disclosure.

### Image Forming System

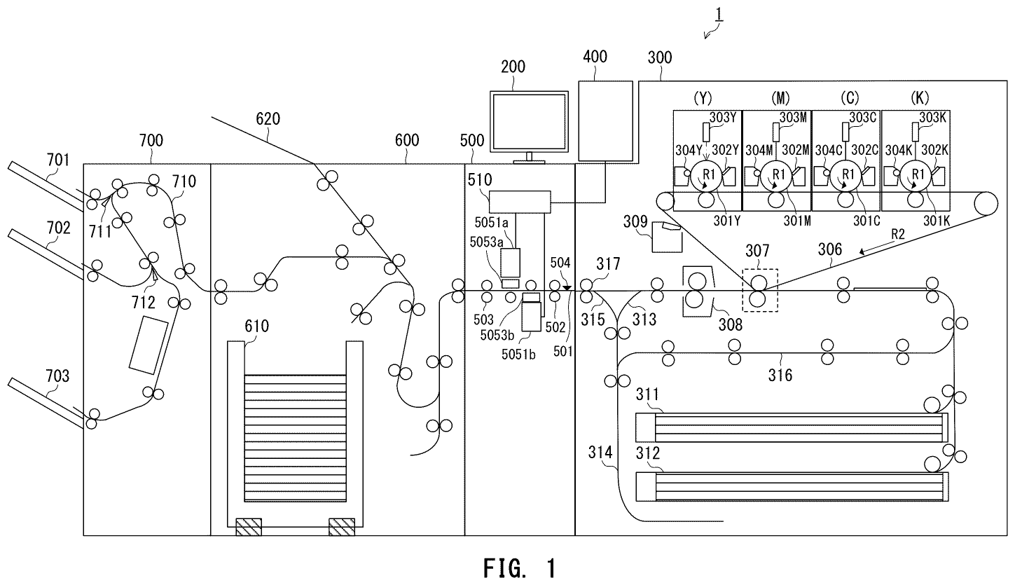

FIG. 1 is a configuration diagram of an image forming system including an inspection apparatus according to this embodiment. An image forming system 1 includes an operating device 200, a printer 300 serving as an image forming apparatus (also referred to as “printing apparatus”), a controller 400, an inspection apparatus 500, a stacker 600, and a finisher 700 serving as a post-processing apparatus.

The operating device 200 is a user interface provided with an input interface and an output interface. The input interface is, for example, a key button and a touch panel. The output interface is, for example, a display and a speaker. The operating device 200 transmits, to the controller 400, an instruction and data that have been input from the input interface. In addition, the operating device 200 outputs information from the output interface in response to an instruction received from the controller 400.

The controller 400 controls operations of the printer 300, the inspection apparatus 500, the stacker 600, and the finisher 700 based on instructions and data that have been input from the operating device 200 or instructions and data that have been acquired from an external apparatus through a network. For example, to perform image formation, the controller 400 transmits an instruction for the image formation to the printer 300. Details of the controller 400 are described later.

### Printer

The printer 300 in this embodiment is a color image forming apparatus that prints a color image on a sheet, but the present disclosure can also be applied to a monochrome image forming apparatus that prints a monochrome image. The printer 300 includes image forming units Y, M, C, and K, an intermediate transfer member 306, a transfer unit 307, a fixing device 308, sheet feeding cassettes 311 and 312, and a feeding mechanism for the sheet. The image forming unis can serve as image formers. The image forming unit Y forms an image of yellow (Y). The image forming unit M forms an image of magenta (M). The image forming unit C forms an image of cyan (C). The image forming unit K forms an image of black (K). The images of the respective colors formed by the image forming units Y, M, C, and K are transferred onto the intermediate transfer member 306 in a superimposed manner. The transfer unit 307 transfers the image borne on the intermediate transfer member 306 onto the sheet. The fixing device 308 fixes, to the sheet, the image transferred onto the sheet.

The respective image forming units Y, M, C, and K have the same configuration, and form the images by the same operation. The following description is directed to a configuration of the image forming unit Y, and descriptions of configurations of the image forming units M, C, and K are omitted. The image forming unit Y includes a photosensitive drum 301Y, a charger 302Y, an exposure device 303Y, and a developing device 304Y.

The photosensitive drum 301Y is a drum-shaped photosensitive member including a photosensitive layer on a surface thereof. During an operation, the photosensitive drum 301Y is rotated in a direction indicated by an arrow R1 about a drum axis. The charger 302Y uniformly charges the surface of the photosensitive drum 301Y being rotated. The exposure device 303Y acquires image data representing an image of yellow from the controller 400, and outputs a laser beam in accordance with this image data. The laser beam output from the exposure device 303Y scans the charged surface of the photosensitive drum 301Y in a drum axis direction. The laser light scans the surface of the photosensitive drum 301Y being rotated, to thereby form an electrostatic latent image corresponding to the image data of yellow on the surface of the photosensitive drum 301Y. The developing device 304Y stores a yellow developer (e.g., toner), and uses the developer to develop the electrostatic latent image formed on the photosensitive drum 301Y. Thus, a yellow image is formed on the surface of the photosensitive drum 301Y. The developing device 304Y is configured so that a developer can be constantly supplied thereto from a toner cartridge (not shown).

In the same manner, a magenta image is formed on a photosensitive drum 301M of the image forming unit M. A cyan image is formed on a photosensitive drum 301C of the image forming unit C. A black image is formed on a photosensitive drum 301K of the image forming unit K.

The intermediate transfer member 306 is an endless belt member, and is rotated in a direction indicated by an arrow R2. The intermediate transfer member 306 is in contact with the respective photosensitive drums 301Y, 301M, 301C, and 301K. In accordance with the rotation of the intermediate transfer member 306, the images of the respective colors are transferred from the respective photosensitive drums 301Y, 301M, 301C, and 301K in order so as to be superimposed one on another. Thus, a full-color image is borne on the intermediate transfer member 306. The intermediate transfer member 306 conveys the full-color image borne thereon to the transfer unit 307 by being rotated.

Sheets are stored in each of the sheet feeding cassettes 311 and 312, and are conveyed from the sheet feeding cassettes 311 and 312 to the transfer unit 307 by the feeding mechanism. A sheet is conveyed in accordance with a timing at which the image borne on the intermediate transfer member 306 is conveyed to the transfer unit 307. The transfer unit 307 transfers the image from the intermediate transfer member 306 onto the sheet. A cleaner 309 is arranged on a downstream side of the transfer unit 307 in a rotation direction of the intermediate transfer member 306. The cleaner 309 removes a developer remaining on the intermediate transfer member 306 after the transfer.

The sheet onto which the image has been transferred is conveyed from the transfer unit 307 to the fixing device 308. The fixing device 308 includes a fixing roller having a heater and a pressure roller. The fixing device 308 uses heat from the heater and pressure from the pressure roller to melt the image and fix the image to the sheet.

Conveying paths 313, 314, and 315, a duplex conveying path 316, and discharge rollers 317 are provided on a downstream side of the fixing device 308 in a conveying direction of the sheet. The sheet that has passed through the fixing device 308 is temporarily conveyed from the conveying path 313 to the conveying path 314. After a trailing end of the sheet has passed through the conveying path 313, the conveying direction is reversed to convey the sheet from the conveying path 315 to the discharge rollers 317. With such conveyance, the sheet is discharged from the printer 300 by the discharge rollers 317 with an image-formed side facing downward (face down). A printed matter, which is the sheet that has been subjected to the image formation and discharged from the printer 300 by the discharge rollers 317, is passed over to the inspection apparatus 500. In a case where the sheet is discharged with an image-formed side facing upward (face up), the sheet that has passed through the fixing device 308 is not conveyed to the conveying path 313 but is directly conveyed to the discharge rollers 317 to be discharged.

In a case where duplex printing is to be performed on the sheet, the sheet conveyed to the conveying path 314 is conveyed to the duplex conveying path 316 after the trailing end has passed through the conveying path 313. The sheet is conveyed again to the transfer unit 307 through the duplex conveying path 316. Due to the passage through the conveying path 314 and the duplex conveying path 316, a side of the sheet on which the image has been formed is turned over. The turned-over side of the sheet is subjected to image transferring processing by the transfer unit 307 and fixing processing by the fixing device 308, to thereby form an image on this side. The sheet having images formed on both sides is discharged as a printed matter from the printer 300 by the discharge rollers 317, and is passed over to the inspection apparatus 500.

### Inspection Apparatus

The inspection apparatus 500 includes a conveying path 501, an inspection controller 510, a first reader 5051a, a second reader 5051b, flow reading glasses 5053a and 5053b, conveying rollers 502 and 503, and a sheet detection sensor 504. The inspection apparatus 500 functions as a reading device that reads an image on the sheet. Under the control of the controller 400, the inspection controller 510 controls the operation of the inspection apparatus 500. Details of the inspection controller 510 are described later. The first reader 5051a and the second reader 5051b are arranged at positions opposed to each other across the conveying path 501. The flow reading glass 5053a is provided between the first reader 5051a and the conveying path 501. The flow reading glass 5053b is provided between the second reader 5051b and the conveying path 501. The conveying rollers 502 and 503 convey the printed matter along the conveying path 501.

The inspection apparatus 500 detects the printed matter conveyed on the conveying path 501 by the sheet detection sensor 504, and reads the images printed on the printed matter by the first reader 5051a and the second reader 5051b. The first reader 5051a and the second reader 5051b transmit reading results of the printed matter to the inspection controller 510. The inspection controller 510 performs a quality inspection of the images printed on the printed matter based on the image data used in a case where the printer 300 prints the images on the sheet and reading results of the printed matter obtained by the first reader 5051a and the second reader 5051b. The first reader 5051a and the second reader 5051b are arranged so as to be opposed to each other across the conveying path 501, and hence the images printed on both sides of the printed matter are read in one time of conveyance of the printed matter. The printed matter from which the images have been read is conveyed from the inspection apparatus 500 to the stacker 600.

### Stacker and Finisher

The stacker 600 includes a large-capacity tray 610 and a purge tray 620. The stacker 600 discharges a printed matter to any one of the large-capacity tray 610, the finisher 700, and the purge tray 620 based on an instruction received from the controller 400 and the results of the quality inspection performed by the inspection controller 510. For example, the stacker 600 discharges, onto the purge tray 620, the printed matter for which the image printed on the sheet has been determined to be abnormal through the quality inspection.

The finisher 700 includes a printed matter conveyor 710 including a plurality of conveying rollers and conveying paths, an upper-stage delivery tray 701, a middle-stage delivery tray 702, and a lower-stage delivery tray 703. The printed matter conveyor 710 includes switching mechanisms 711 and 712 for switching a discharge destination of the printed matter. The finisher 700 takes in printed matters from the stacker 600 in order, and discharges each of the printed matters to any one of the upper-stage delivery tray 701, the middle-stage delivery tray 702, and the lower-stage delivery tray 703 in response to an instruction received from the controller 400. The finisher 700 may be configured to perform post-processing, such as staple processing for binding and stapling a plurality of printed matters, bookbinding processing for the bound printed matters, and cut-off processing for the bound printed matters.

### Controller

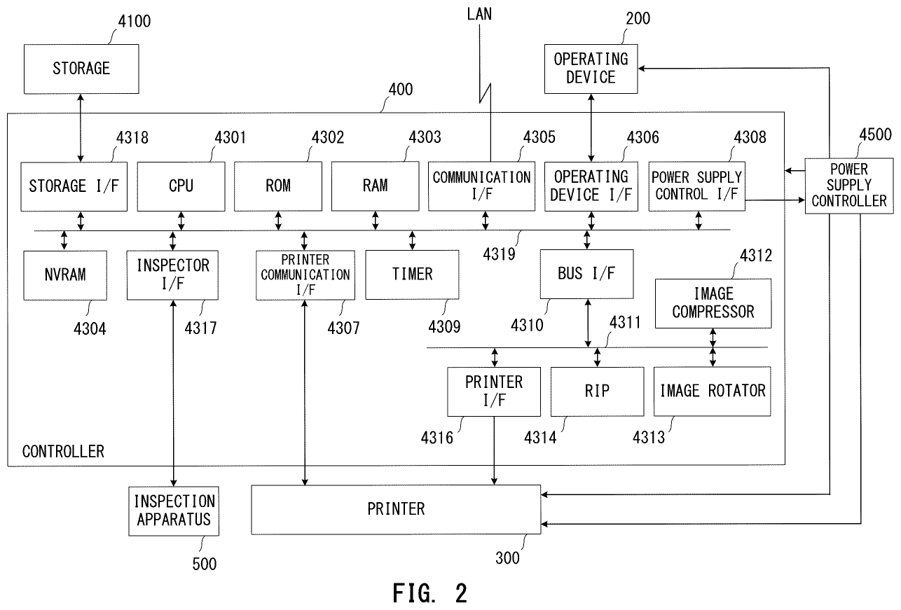

FIG. 2 is an explanatory diagram of a configuration of the controller 400. In addition to the operating device 200, the printer 300, and the inspection apparatus 500 described above, the controller 400 is connected to a storage 4100 and a power supply controller 4500. As interfaces with the respective components to be connected, the controller 400 includes a storage I/F 4318, an operating device I/F 4306, a power supply control I/F 4308, an inspector I/F 4317, a printer communication I/F 4307, and a printer I/F 4316. The controller 400 also includes a communication I/F 4305 for communicating to/from an external apparatus through the network (local area network (LAN) in FIG. 2). The storage I/F 4318, the communication I/F 4305, the operating device I/F 4306, the power supply control I/F 4308, the inspector I/F 4317, and the printer communication I/F 4307 are connected to a system bus 4319. The printer I/F 4316 is connected to the image bus 4311. The system bus 4319 and the image bus 4311 are connected via a bus I/F 4310.

The controller 400 is an information processing device including a central processing unit (CPU) 4301, a read only memory (ROM) 4302, and a random access memory (RAM) 4303. The CPU 4301 executes a computer program stored in the ROM 4302 to control an operation of the image forming system 1. The RAM 4303 provides a work area for the CPU 4301 to execute processing. The RAM 4303 is also used as an image memory for temporarily storing image data and the like. The CPU 4301, the ROM 4302, and the RAM 4303 are also connected to the system bus 4319. A non-volatile RAM (NVRAM) 4304 and a timer 4309 are also connected to the system bus 4319. The NVRAM 4304 stores various parameters for control. The timer 4309 holds a current time, and monitors passage of a set time period.

The operating device I/F 4306 controls communication to/from the operating device 200. The operating device I/F 4306 receives input of print jobs, commands, and printing settings, which is performed from the operating device 200 to the controller 400, and transmits the input information to the CPU 4301. Under the control of the CPU 4301, the operating device I/F 4306 transmits data for displaying various screens and states of the image forming system 1 to the operating device 200.

Under the control of the CPU 4301, the printer communication I/F 4307 controls communication to/from the printer 300. The power supply control I/F 4308 instructs the power supply controller 4500 to supply or stop various kinds of electric power in accordance with a command received from the CPU 4301. The power supply controller 4500 supplies electric power to the printer 300. Under the control of the CPU 4301, the inspector I/F 4317 controls communication to/from the inspection apparatus 500. Under the control of the CPU 4301, the storage I/F 4318 controls communication to/from the storage 4100. The communication I/F 4305 is connected to a network, and performs communication control, such as transmission and reception of an email and inputting and outputting of PDL data from an external apparatus. The communication I/F 4305 also includes an NVRAM (not shown), and holds various parameters relating to communication control, such as a MAC address.

The bus I/F 4310 is a bridge that connects the system bus 4319 and the image bus 4311 to each other. The image bus 4311 is connected to an image compressor 4312, an image rotator 4313, and a raster image processor (RIP) 4314 in addition to the printer I/F 4316 in order to transfer image data to the printer 300.

The image compressor 4312 performs compression and decompression processing for JPEG, JBIG, MMR, MH, and the like. The image rotator 4313 performs image rotation processing. The RIP 4314 expands PDL code into a bitmap raster image. The printer I/F 4316 transmits image data to the printer 300. This image data is generated by the controller 400 subjecting image data to be output to the printer 300 to image processing for the printer 300, such as correction for the printer 300 and resolution conversion.

### Inspection Controller

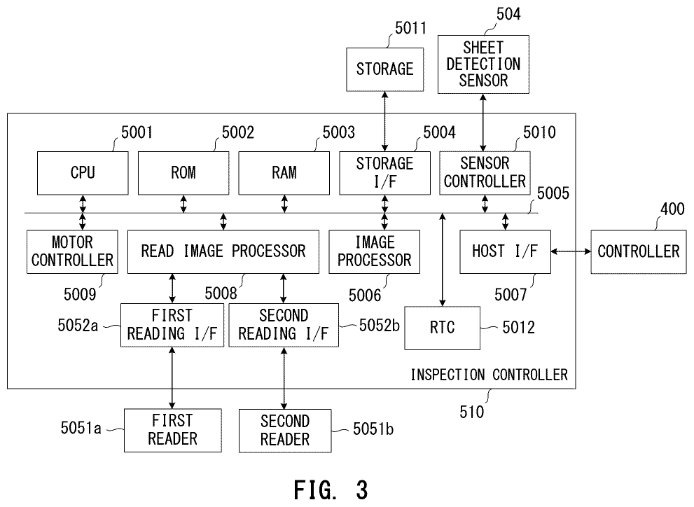

FIG. 3 is an explanatory diagram of a configuration of the inspection controller 510 provided to the inspection apparatus 500. The inspection controller 510 controls operations of the first reader 5051a and the second reader 5051b. The inspection controller 510 performs processing, such as analysis of the reading results (read images) obtained by the first reader 5051a and the second reader 5051b, operation control of the inspection apparatus 500, and communication to/from the controller 400. The inspection apparatus 500 transmits the inspection results of the printed matter to the controller 400. The inspection controller 510 is connected to a storage 5011 for storing a misregistration correction profile and the like, and the controller 400.

The inspection controller 510 includes a CPU 5001, a ROM 5002, a RAM 5003, a storage I/F 5004, a motor controller 5009, a read image processor 5008, an image processor 5006, an RTC 5012, a host I/F 5007, and a sensor controller 5010. The respective components are connected to a system bus 5005. The read image processor 5008 is connected to the first reader 5051a through a first reading I/F 5052a, and is connected to the second reader 5051b through a second reading I/F 5052b. The RTC 5012 is a real-time clock, and holds the current time with high accuracy. The host I/F 5007 controls communication to/from the inspector I/F 4317 of the controller 400. In a case where the inspection controller 510 and the controller 400 communicate to/from each other, data is transmitted and received between the host I/F 5007 and the inspector I/F 4317. For example, the host I/F 5007 acquires image data used for an image forming operation of the printer 300 from the controller 400.

The CPU 5001 executes a computer program stored in the ROM 5002 to control the operation of the inspection apparatus 500. The RAM 5003 provides a work area for the CPU 5001 to execute processing. The storage I/F 5004 controls communication to/from the storage 5011 connected to the inspection controller 510. The storage 5011 is a large-capacity storage device, such as an HDD or an SSD. The image data acquired from the controller 400 is stored in the storage 5011 as reference image data.

The read image processor 5008 is controlled by the CPU 5001 to control the first reader 5051a to acquire the reading result of the image on the printed matter from the first reader 5051a through the first reading I/F 5052a. The read image processor 5008 is also controlled by the CPU 5001 to control the second reader 5051b to acquire the reading result of the image on the printed matter from the second reader 5051b through the second reading I/F 5052b. Under the control of the CPU 5001, the read image processor 5008 performs magnification processing, gamma correction processing, and the like on the reading results of the images on the printed matter, which have been acquired from the first reader 5051a and the second reader 5051b, to generate read image data, and stores the read image data in the RAM 5003. The read image data is the read image data to be inspected.

The first reader 5051a and the second reader 5051b are each provided with a sensor array, for example, and are each capable of reading an entire region of the printed matter conveyed on the conveying path 501. The first reader 5051a reads an image on a first side of a printed matter, and the second reader 5051b reads an image on a second side of the printed matter.

The first reader 5051a and the second reader 5051b are each formed of a light emitter and a light receiver. The light emitter is formed of, for example, a white light emitting diode (LED). The light receiver is formed of, for example, a CMOS sensor equipped with an RGB color filter. The light emitter is controlled by the CPU 5001 to irradiate the printed matter being conveyed along the conveying path 501 with light. The light receiver receives the light reflected by the printed matter by separating the light into three color components of RGB through use of the color filter, and outputs read image data as a light reception result. The read image data is transmitted to the read image processor 5008.

Under the control of the CPU 5001, the motor controller 5009 controls operations of various motors provided in the inspection apparatus 500. Under the control of the CPU 5001, the sensor controller 5010 controls the operations of various sensors provided in the inspection apparatus 500, and notifies the CPU 5001 of detection results obtained by the sensors. For example, the sensor controller 5010 notifies the CPU 5001 of the detection result of a sheet from the sheet detection sensor 504. This notification enables the CPU 5001 to detect that the printed matter has been passed over from the printer 300 to the inspection apparatus 500. In a case where the CPU 5001 detects that the printed matter has been passed over from the printer 300 to the inspection apparatus 500, the CPU 5001 prepares the first reader 5051a and the second reader 5051b to read the printed matter.

The image processor 5006 is an inspector that performs a quality inspection of the printed matter by comparing the reference image data stored in the storage 5011 to the read image data stored in the RAM 5003 under the control of the CPU 5001. The reference image data not only may be image data used for image formation by the printer 300 as described above, but also may be image data obtained by reading a reference image in advance before the quality inspection is performed. At a time of comparison, the image processor 5006 subjects the reference image data to correction processing using parameters based on calibration. In a case where the image printed on the sheet is determined to be abnormal by the quality inspection, information such as a position of an abnormal spot (abnormal image) and a type (such as dot image or streaked image) of the abnormal image is obtained. The information indicating results of the quality inspection is transmitted to the controller 400.

### Inspection Settings

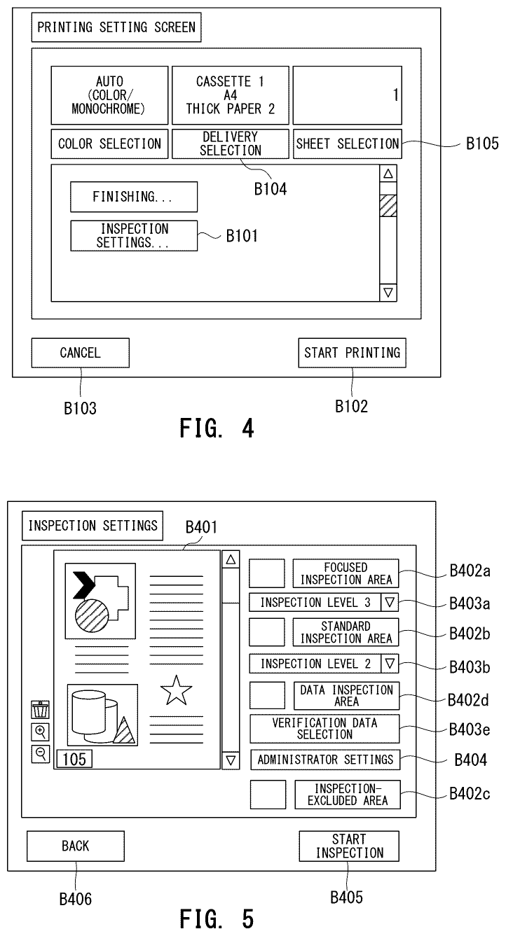

FIG. 4 is an exemplary view of an operation screen displayed on the display of the operating device 200 during printing inspection processing for generating a printed matter and performing a quality inspection thereon. The operation screen displayed on the display allows a user to set quality inspection items and instruct execution of the printing inspection processing through use of the input interface of the operating device 200. The inspection apparatus 500 performs the printing inspection processing in accordance with the quality inspection items that have been set.

This operation screen allows the user to set printing processing and whether or not to perform a quality inspection. Use of buttons B101 to B105 displayed on this setting screen allows the user to select the color (color or monochrome) at a time of printing, selection of a type of sheet, a setting of a discharge destination or the like of a printed matter, and selection of execution of calibration.

The button B101 is an inspection setting button, and in a case where the button B101 is pressed, an inspection setting screen exemplified in FIG. 5 is displayed on the display of the operating device 200. The button B102 is a print start button, and in a case where the button B102 is pressed, formation of a printed matter is started without performing a quality inspection by the inspection apparatus 500. The button B103 is a cancel button, and in a case where the button B103 is pressed, settings are canceled, and a predetermined initial screen is displayed on the display of the operating device 200. The button B104 is a delivery tray setting button for setting the discharge destination of the printed matter. The button B105 is a button for selecting a sheet to be used for printing, and in a case where the button B105 is pressed, it is possible to confirm and change a size, a basis weight, and the like of the sheets stored in the sheet feeding cassettes 311 and 312, and to designate a sheet feeding source.

FIG. 5 is an exemplary view of the inspection setting screen displayed on the display of the operating device 200 in a case where the button B101 is pressed. The inspection setting screen is a screen for setting an inspection area for which an inspection such as the quality inspection by the inspection apparatus 500 is to be executed and a type of inspection.

An area B401 of the inspection setting screen is a display portion for a print image to be printed on the sheet and an inspection setting area. In the area B401, an image based on a print job is displayed. The inspection area is set by the user selecting an image display region in the area B401 under a state in which inspection area type buttons indicated by buttons B402a to B402d are selected. The button B402a is a focused inspection area button for setting a region (focused inspection area) for which a high-precision inspection is to be performed. The button B402b is a standard inspection area button for setting a region (standard inspection area) for which a standard inspection is to be performed. The button B402c is an inspection-excluded area button for designating a region (inspection-excluded area) for which no inspection is to be performed. The button B402d is a data inspection area button for recognizing and inspecting a region (data inspection area) such as characters or a bar code. The inspection area types are not limited to those four types.

Buttons B403a and B403b are inspection level setting buttons for setting inspection levels for the respective inspection areas. The inspection levels are set in terms of inspection accuracy stepwise, for example, from an inspection level 1 to an inspection level 5. The user can set the inspection levels for the respective regions to be set through use of the buttons B403a and B403b. The button B403a is a button for setting the inspection level for the focused inspection area. The button B403b is a button for setting the inspection level for the standard inspection area. In this example, the inspection level 1 indicates the lowest inspection accuracy, and the inspection accuracy becomes higher as the inspection level number becomes larger. A button B403e is a verification data selection button. The button B403e is used to select a data file (verification data) against which a decoded result in the area designated by the button B402d is to be verified. The verification data is data representing an image to be used for determining a normal image printed on the sheet. The verification data is, for example, a user image including an image of a bar code or a serial number.

A button B404 is an administrator setting button. In a case where the button B404 is pressed, the screen displayed on the display transitions to a password input screen for transitioning to a screen for switching whether or not to permit access to the verification data and submitted data in a case in which the inspection results indicate an abnormality. The submitted data corresponds to, for example, the reference image data stored in the storage 5011. The submitted data is data representing an image in which variable data is embedded. The submitted data is, for example, PDF data including an image of a bar code or a serial number generated based on a data file having a comma separated values (CSV) format. A button B405 is an inspection start button. In a case where the button B405 is pressed, the printing inspection processing is started. A button B406 is a button for returning to the previous screen. In a case where the button B406 is pressed, inspection setting processing is canceled, and the screen displayed on the display returns to a printing setting screen of FIG. 4.

For example, the user can select a region for which a high-precision inspection is to be performed by selecting the button B402a and selecting a region for which a high-precision inspection is required to be performed from the area B401 by a mouse, a touch panel, or the like. In the example of FIG. 5, a region including graphic forms such as a circle and a plus-sign shape is selected as the focused inspection area for which a high-precision inspection is to be performed. A region including cylindrical shapes and a triangle is set as the inspection-excluded area due to no high-precision inspection being required to be performed.

Through settings of the inspection levels in the above-mentioned manner, memory and throughput required for the inspection can be suppressed compared to when an entire image is inspected without settings of the inspection levels. Further, through settings of the inspection levels stepwise, for example, from the inspection level 1 to the inspection level 5, the memory and throughput required for the inspection can be suppressed compared to when the inspection is always performed with a high inspection level of accuracy.

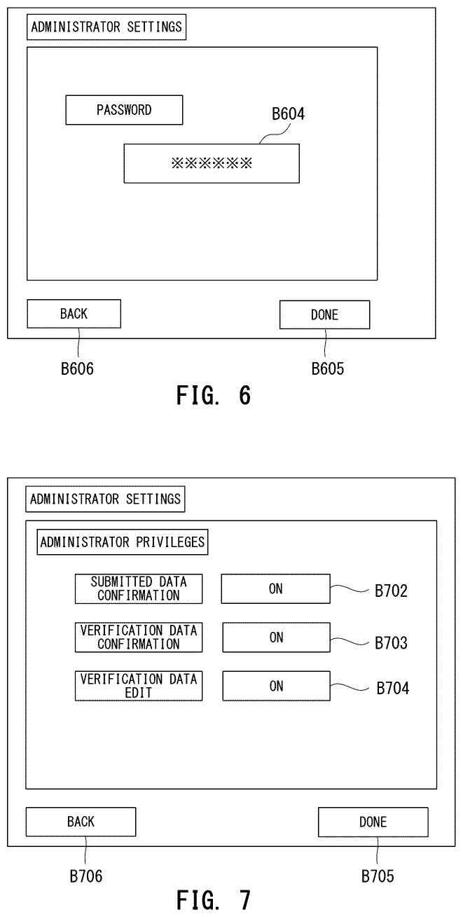

FIG. 6 is an exemplary view of the password input screen displayed on the display in a case where the button B404 is pressed. The password input screen includes a password input portion B604, a determination button B605, and a back button B606. In the password input portion B604, a password is input by the user through use of the input interface. The determination button B605 causes an administrator setting screen to be displayed on the display in a case where the determination button B605 is pressed under a condition that the password has been correctly input. The administrator setting screen is a screen capable of switching whether or not to permit access to the verification data and the submitted data in a case where the inspection results indicate an abnormality. The back button B606 is a button for returning to the previous screen, and in a case where the back button B606 is pressed, the password is canceled, and the screen displayed on the display returns to the inspection setting screen of FIG. 5.

FIG. 7 is an exemplary view of the administrator setting screen. As described above, the administrator setting screen is displayed on the display only when the correct password is input on the password input screen of FIG. 6. The administrator setting screen is used to perform display settings of shortcut buttons for displaying data relating to the abnormal image.

A button B702 is a submitted data confirmation setting button. In a case where the button B702 is set to “ON,” a shortcut button for accessing the submitted data is displayed in the case in which the inspection results indicate an abnormality. The shortcut button for accessing the submitted data is described later.

A button B703 is a verification data confirmation setting button. In a case where the button B703 is set to “ON,” a shortcut button for accessing the verification data is displayed in the case in which the inspection results indicate an abnormality. The shortcut button for accessing the verification data is described later.

A button B704 is a verification data edit setting button. In a case where the button B704 is set to “ON,” a shortcut button for editing the verification data is displayed in the case in which the inspection results indicate an abnormality. The shortcut button for editing the verification data is described later.

A button B705 is a determination button. In a case where the button B705 is pressed, the screen displayed on the display returns to the inspection setting screen of FIG. 5 with setting changes made by the buttons B702, B703, and B704 having been enabled. A button B706 is a button for returning to the previous screen. In a case where the button B706 is pressed, the screen displayed on the display returns to the inspection setting screen of FIG. 5 with the setting changes having been canceled.

### Screen in Case in which Inspection Result Indicates Abnormality

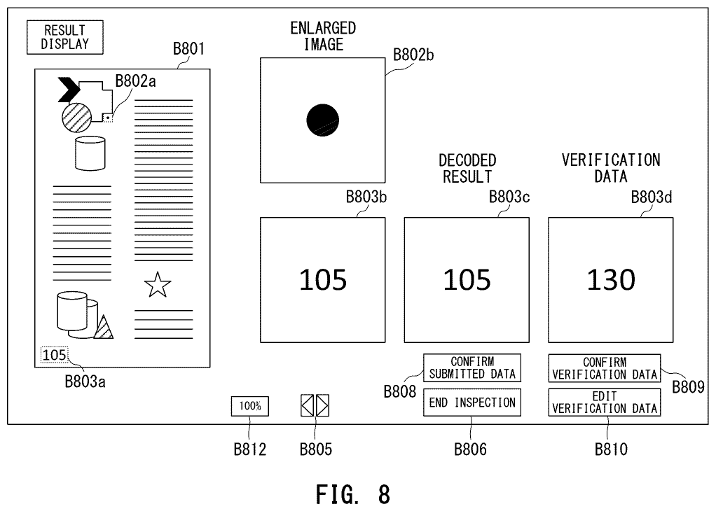

FIG. 8 is an exemplary view of an inspection result display screen obtained in a case where the inspection results of the printed matter indicate an abnormality. The inspection result display screen is displayed on the display in a case where the inspection results obtained by the inspection apparatus 500 indicate that there is an abnormality in the image printed on the sheet. On the inspection result display screen, an image for showing a position of the image (abnormal image) determined to be abnormal, the details of the abnormal image, a degree of the abnormality, a link to related information on the details of the abnormal image, and the like are displayed.

In an area B801, an inspection result image including an entire image of the printed matter determined to be abnormal by the inspection and the position of each abnormal image (abnormal spot display area) in the entire image is displayed. The area B801 includes areas B802a and B803a as abnormal spot display areas. The abnormal spot display areas indicate the positions of the abnormal images in the area B801.

The area B802a indicates the position of a first abnormal image in the entire image that has been determined to be abnormal by the inspection. The first abnormal image is an abnormal image in a region set as the “standard inspection area” or “focused inspection area” on the inspection setting screen of FIG. 5. The area B803a indicates the position of a second abnormal image in the entire image that has been determined to be abnormal by the inspection. The second abnormal image is an abnormal image in a region set as the “data inspection area”on the inspection setting screen of FIG. 5.

An image B802b is an enlarged image of the area B802a. An image B803b is an enlarged image of the area B803a. An image B803c is a decoded result of characters in the area B803a. An image B803d indicates verification data that is a result of verification of the characters in the area B803a and the decoded result.

In this manner, the image B802b and the images B803b to B803d indicate the enlarged images of the abnormal image, the decoded result, and the verification data. That is, the images B802b and B803b to B803d indicate the details of the abnormal image and the degree of the abnormality.

An image B805 represents left and right buttons for switching between pages of the printed matter that has been determined to be abnormal by the inspection. In a case where any one of the left and right buttons of the image B805 is clicked, the pages of the printed matter that has been determined to be abnormal are switched. For example, in a case where the left button is clicked, the page of the printed matter that has been determined to be abnormal is switched to the previous page, and in a case where the right button is clicked, the page of the printed matter that has been determined to be abnormal is switched to the subsequent page. A button B806 is an inspection end button. In a case where the user presses the button B806 after having finished examining the inspection results of the printed matter, the inspection of the printed matter is ended.

A button B808 is a shortcut button to the submitted data. The button B808 is displayed in a case where the button B702 that is the submitted data confirmation setting button is set to “ON.” In a case where the user presses the button B808 at his or her discretion, the screen displayed on the display transitions to the inspection setting screen of FIG. 5. This allows the user to immediately confirm the image (read image) based on the print job displayed in the area B401. In a case where the button B808 is pressed, the submitted data file (image based on the print job) corresponding to the page determined to be abnormal may be displayed in an image viewer or the like separately from the inspection setting screen of FIG. 5.

A button B809 is a shortcut button to the verification data for data inspection. The button B809 is displayed in a case where the button B703 that is the verification data confirmation setting button is set to “ON.” In a case where the user presses the button B809 at his or her discretion, the verification data selected by the button B403e that is the verification data selection button is displayed in a read-only format, to thereby allow the user to confirm the verification data. The button B808 that is a submitted data confirmation button and the button B809 that is a verification data confirmation button are always displayed in a case where the inspection results indicate an abnormality irrespective of the inspection settings or the type of inspection.

A button B810 is a shortcut button for editing the verification data. The button B810 is displayed in a case where the button B704 that is the verification data edit setting button is set to “ON.” In a case where the user presses the button B810 at his or her discretion, the verification data selected by the button B403e that is the verification data selection button is displayed, to thereby allow the user to edit the verification data.

In this manner, the buttons B808, B809, and B810 represent the shortcut buttons for displaying data relating to the details of the abnormal image. The user can confirm detailed information relating to the abnormal image by pressing the buttons B808, B809, and B810.

In a text box B812, a display ratio (%) of the inspection result image displayed in the area B801 to the entire inspection result image is displayed. The display ratio represents a ratio, namely, a scale ratio, of the image displayed in the area B801 to the entire image of the inspection result image set to be 100%. In the example of FIG. 8, the display ratio is 100%. The display ratio can be changed by an operation performed by the user. In a case where the display ratio is set to less than 100%, a part (partial image) of the inspection result image is displayed in the area B801 in an enlarged manner at a ratio corresponding to the display ratio.

In FIG. 8, the user can easily recognize the state of the abnormal image based on the image B802b that is the enlarged image of the area B802a. The user can compare the submitted data to the image B802b by pressing the button B808 to confirm the original submitted data. The user can easily recognize the state of the abnormal image based on the image B803b that is the enlarged image of the characters in the area B803a. The user can confirm both the submitted data and the verification data based on the displayed image B803c and image B803d. That is, the user can easily examine whether there is an error in the image of the submitted data or whether there is an error in the verification data by appropriately pressing the button B808, the button B809, and the button B810, and can perform appropriate correction as the requirement arises. This can shorten a time period required for confirmation, examination, and correction, and can resultantly reduce time and effort required to resolve the abnormality.

### Partial Image Display

The button B808 and the button B809 of FIG. 8 are displayed when there is an abnormality in the inspection results irrespective of the type of inspection. As described above, in the text box B812, the display ratio (%) of the inspection result image displayed in the area B801 to the entire inspection result image is displayed. In a case where the display ratio displayed in the text box B812 is changed to less than 100%, a partial image of a part of the inspection result image is displayed in an enlarged manner.

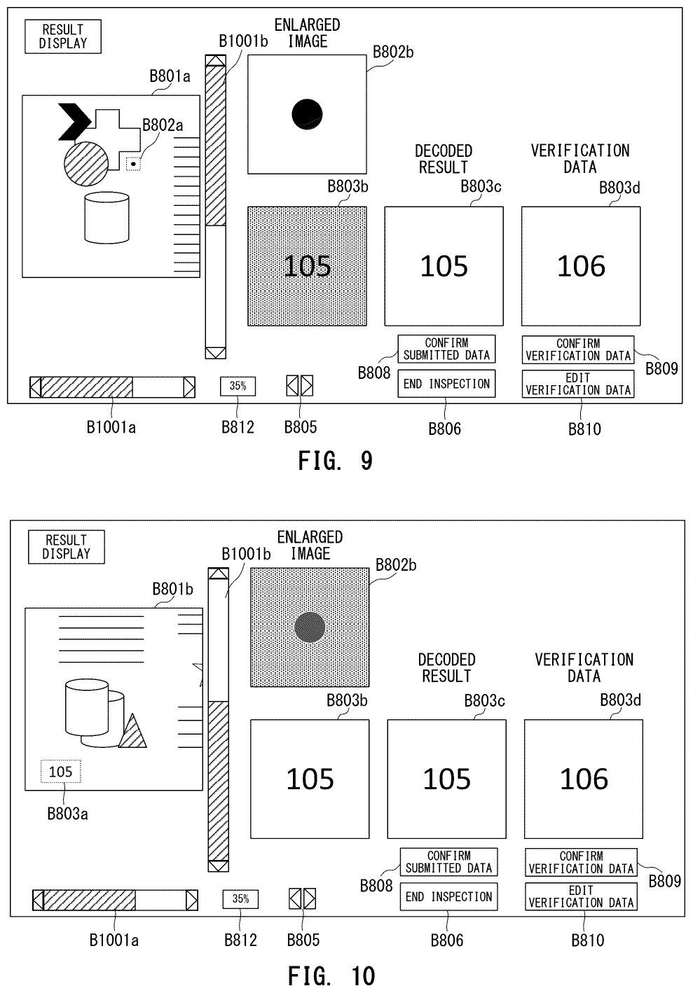

FIG. 9 and FIG. 10 are each an exemplary view of the inspection result display screen on which a partial image of the inspection result image of FIG. 8 is displayed in an enlarged manner. In this example, the display ratio is set to 35%. Partial images of 35% of the inspection result image are displayed in an enlarged manner so as to fit a size of areas B801a and B801b.

In the area B801a of FIG. 9, an upper left partial image of the inspection result image in the area B801 of FIG. 8 is displayed in an enlarged manner. Scroll bars B1001a and B1001b are provided for the area B801a. In a case where the left-right-direction scroll bar B1001a is operated, a position of the partial image in the inspection result image is moved in a left-right direction within the inspection result image. In a case where the up-down-direction scroll bar B1001b is operated, the position of the partial image in the inspection result image is moved in an up-down direction within the inspection result image.

In FIG. 9, as the first abnormal image in the area B802a that is displayed in the partial image displayed in the area B801a, the image B802b that is the enlarged image is displayed in a normal display state. For the second abnormal image in the area B803a that is not displayed in the partial image displayed in the area B801a, the image B803b that is the enlarged image is displayed in a dimmed state instead of being displayed in a normal display state.

In the area B801b of FIG. 10, a lower left partial image of the inspection result image in the area B801 of FIG. 8 is displayed in an enlarged manner. In a case where the up-down-direction scroll bar B1001b is operated on the screen of FIG. 9 and moved downward to scroll the area B801, the inspection result display screen of FIG. 10 is displayed. In FIG. 10, as the second abnormal image in area B803a that is displayed in the partial image displayed in the area B801b, the image B803b that is the enlarged image is displayed in a normal display state. For the first abnormal image in the area 802a that is not displayed in the partial image displayed in the area B801b, the image B802b that is the enlarged image is displayed in a dimmed state instead of being displayed in a normal display state.

As described above, in FIG. 9 and FIG. 10, the enlarged images corresponding to the abnormal images that are not displayed in the partial images displayed in an enlarged manner in the area B801 is displayed in a dimmed state. Through displaying of the inspection results in the above-mentioned manner, the enlarged image of the abnormal image that is not displayed in the partial image of the inspection result image can be visually clearly distinguished, thereby enhancing visibility of the user and improving workability.

The display state of the enlarged image of the abnormal image that is not displayed in the partial image is not limited to the dimmed-state display, as long as the display state is different from a normal display state. For example, a color of a frame around the enlarged image may be set to a color (for example, red) different from the normal display. Further, the enlarged image may be marked with an X mark or the like to emphasize that it is the enlarged image of the abnormal image that is not displayed in the partial image. In another example, in a case where a mouse pointer is used as described below, an image density of the enlarged image may be changed (for example, the image density may become lower) in a case where the mouse pointer is brought closer to the enlarged image.

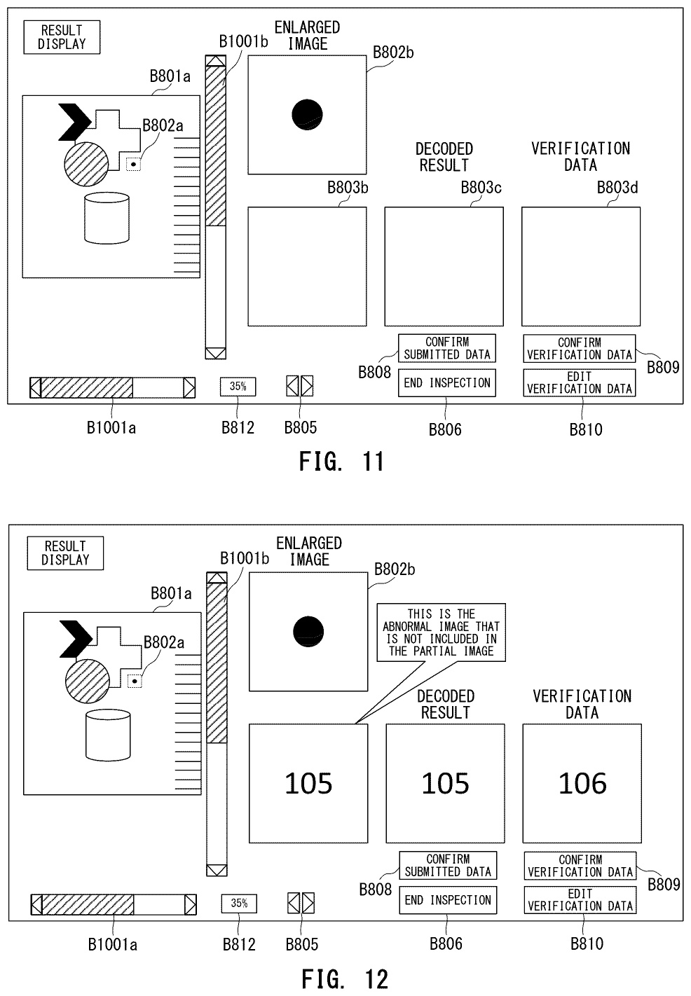

The enlarged image of the abnormal image that is not displayed in the partial image is not required to be displayed. FIG. 11 is an exemplary view of a state in which the enlarged image of the abnormal image that is not displayed in the partial image is not displayed. In addition, a message indicating that the abnormal image is not displayed in the partial image may be attached to the enlarged image of the abnormal image that is not displayed in the partial image. FIG. 12 is an exemplary view of a case in which the message is displayed. The message of FIG. 12 is displayed in a callout, but may be displayed in, for example, a box connected by a leader line.

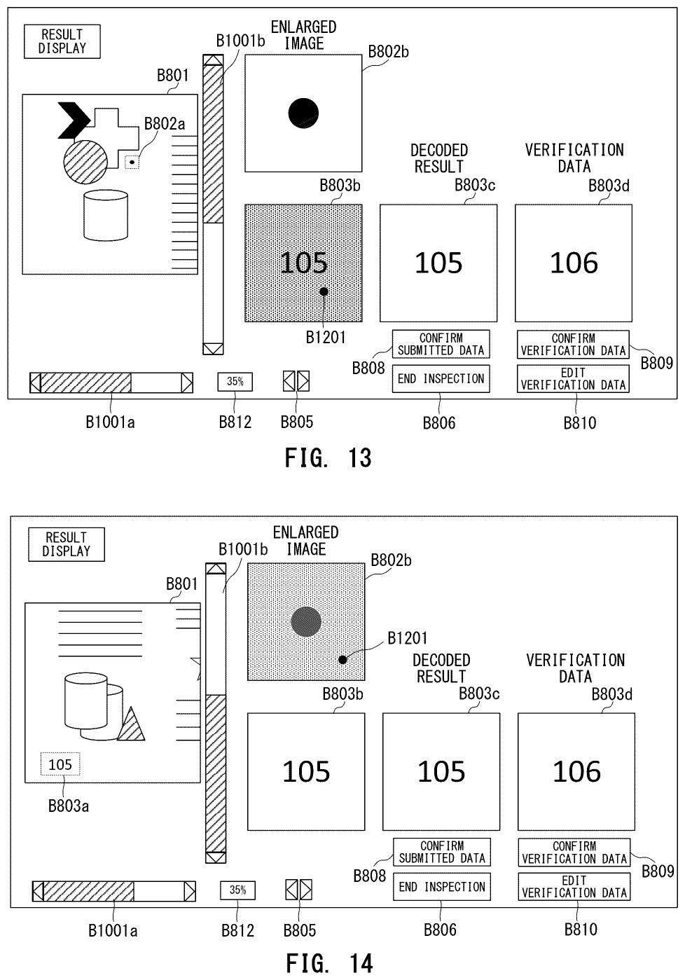

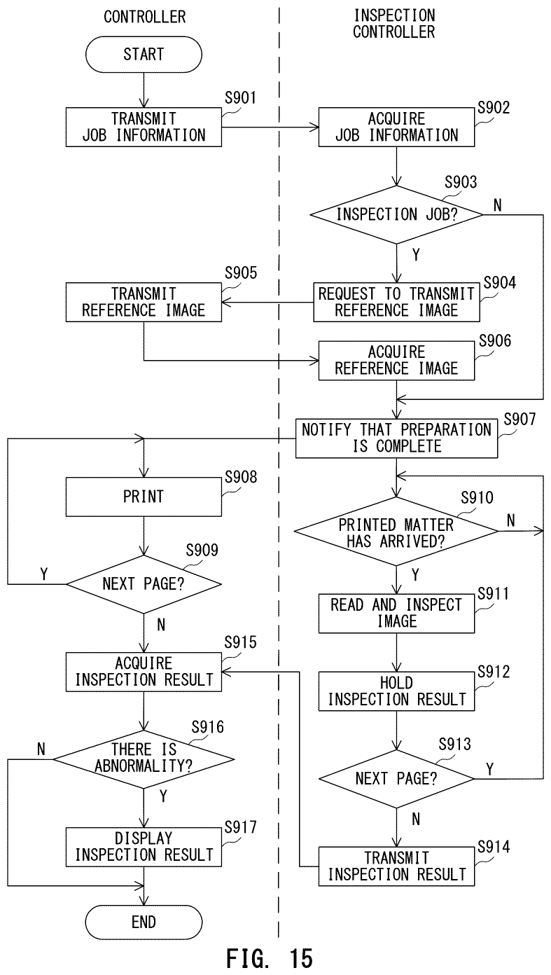

FIG. 13 and FIG. 14 are each an explanatory diagram of a procedure for shifting the inspection result display screen of FIG. 9 to the inspection result display screen of FIG. 10. FIG. 13 has the same screen configuration as that of FIG. 9, and FIG. 14 has the same screen configuration as that of FIG. 10.

In a first procedure, the scroll bars B1001a and B1001b are used. For example, in a case where the up-down-direction scroll bar B1001b is moved downward, the display of the inspection result image shifts from FIG. 13 to FIG. 14. The scroll bar B1001b is moved through use of, for example, a mouse pointer B1201. That is, the mouse pointer B1201 is moved to an upper portion of the scroll bar B1001b, and under this state, the scroll bar B1001b is dragged down to be moved downward. The movement of the mouse pointer B1201 and dragging therewith are performed through use of the mouse or the touch panel.

A second procedure is a method of selecting the abnormal image by the mouse pointer B1201. The mouse pointer B1201 is moved or selected through use of the mouse or the touch panel.

As described above, the mouse pointer B1201 is also used to change the display state of the enlarged image of the abnormal image that is not displayed in the partial image. In FIG. 13, in a case where the mouse pointer B1201 is positioned over the image B803b, the display state of the enlarged image of the abnormal image that is not displayed in the partial image in the area B801 is changed. In this case, the image density of the image B803b is changed. In FIG. 14, in a case where the mouse pointer B1201 is positioned over the image B802b, the display state of the enlarged image of the abnormal image that is not displayed in the partial image in the area B801 is changed. In this case, the image density of the image B802b is changed.

In addition, in a case where the enlarged image of the abnormal image is selected by the mouse pointer B1201, the partial image of the inspection result image in the area B801 may be moved to an image of a portion including the selected abnormal image. For example, in a case where the image B803b is clicked (selected) by the mouse pointer B1201 of FIG. 13, the partial image of the area B801 is switched from the image of FIG. 13 to the image of FIG. 14. In a case where the image B802b is clicked (selected) by the mouse pointer B1201 of FIG. 14, the partial image of the area B801 is switched from the image of FIG. 14 to the image of FIG. 13.

There is also a case in which the entire image of the inspection result image is displayed in the area B801 as in FIG. 8. In this case, the image in the area B801 is switched from the entire image of the inspection result image to the image in which the portion including the abnormal image selected by the mouse pointer B1201 is enlarged. For example, in a case where the image B802b is selected by the mouse pointer under the state of FIG. 8, the entire image in the area B801 is switched to the partial image in the area B801 of FIG. 9. In a case where the image B803b is selected by the mouse pointer under the state of FIG. 8, the entire image in the area B801 is switched to the partial image in the area B801 of FIG. 10.

### Print Inspection Processing

FIG. 15 is a processing flow chart for illustrating the printing inspection processing. This processing is executed by the controller 400 (CPU 4301) and the inspection controller 510 (CPU 5001) of the inspection apparatus 500 in cooperation with each other. This processing is started in a case where the button B405 that is the inspection start button is pressed on the inspection setting screen of FIG. 5.

In a case where the button B405 is pressed by the operating device 200, the controller 400 transmits, to the inspection apparatus 500, job information of a print job including sheet information on the sheet to be used for printing, inspection settings, discharge destination, and the like (Step S901). The inspection controller 510 acquires the job information from the controller 400 (Step S902).

The inspection controller 510 determines whether or not the job requires an inspection based on the inspection settings of the acquired job information (Step S903). In a case where the job does not require an inspection (N in Step S903), the inspection controller 510 notifies the controller 400 that preparation for the print job is complete (Step S907).

In a case where the job requires an inspection (Y in Step S903), the inspection controller 510 transmits, to the controller 400, a request to transmit the reference image data for inspection determination (Step S904). In response to the request to transmit the reference image data acquired from the inspection apparatus 500, the controller 400 transmits the image data of the print job to the inspection apparatus 500 as reference image data (Step S905). The inspection controller 510 acquires the reference image data from the controller 400, and stores the reference image data in the storage 5011 (Step S906). Having completed the acquisition of the reference image data, the inspection controller 510 notifies the controller 400 that the preparation for the print job is complete (Step S907).

In a case where the controller 400 acquires a preparation completion notification from the inspection apparatus 500, the controller 400 executes the printing processing by the printer 300 (Step S908). The controller 400 repeatedly performs the printing processing until the number of printed matters instructed in the print job are obtained (Y in Step S909). In a case where the number of printed matters instructed in the print job have been obtained (N in Step S909), the controller 400 waits until the controller 400 acquires the inspection results obtained by the inspection apparatus 500.

The inspection controller 510 determines whether or not the printed matter has arrived at the conveying path 501 of the inspection apparatus 500 based on the detection result from the sheet detection sensor 504 (Step S910). In a case where the printed matter has not arrived (N in Step S910), the inspection controller 510 waits until the printed matter arrives. In a case where the printed matter has arrived (Y in Step S910), the inspection controller 510 sequentially reads the conveyed printed matter by the first reader 5051a and the second reader 5051b. The inspection controller 510 causes the image processor 5006 to perform an image inspection by comparing the read image data representing the reading result to the reference image data (Step S911). The inspection controller 510 holds the inspection results obtained by the image processor 5006 in the RAM 5003 (Step S912).

After that, the inspection controller 510 determines whether or not there is a next page to be printed based on the job information acquired from the controller 400 (Step S913). When there is a next page (Y in Step S913), the inspection controller 510 again executes the processing steps of Step S910 and the subsequent steps to repeatedly perform the inspection processing. When there is no next page (N in Step S913), the inspection controller 510 transmits, to the controller 400, the inspection results held in the RAM 5003 in the processing step of Step S912 (Step S914).

The controller 400 acquires the inspection results obtained by the inspection apparatus 500 (Step S915). The controller 400 determines whether or not there is an abnormality in the acquired inspection results (Step S916). When there is no abnormality (N in Step S916), that is, in a case where the image printed on the sheet is normal, the controller 400 ends the printing inspection processing. In a case where the image printed on the sheet is abnormal (Y in Step S916), the controller 400 controls the operating device 200 to display the inspection result display screen on the display (Step S917). In a case where the user confirms the position of the abnormal image on the inspection result display screen and then presses the button B806 that is the inspection end button, the controller 400 ends the printing inspection processing.

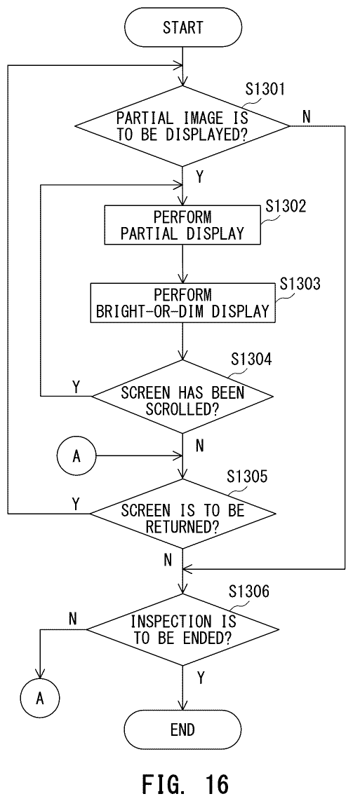

FIG. 16 is a processing flow chart for illustrating processing for displaying the inspection result display screen. This processing is performed with the controller 400 displaying the inspection result display screen of FIG. 8 on the display in the processing step of Step S917. When there is only a single abnormal spot, only one enlarged image is displayed.

The controller 400 determines whether or not to display the partial image of a part of the inspection result image (Step S1301). This determination is performed based on, for example, whether or not the display ratio in the text box B812 of FIG. 8 is set to less than 100%. In a case where the partial image is to be displayed (Y in Step S1301), the controller 400 displays the partial image of the inspection result image corresponding to the display ratio (Step S1302). Therefore, the partial image of the inspection result image is displayed in an enlarged manner in the area B801 as exemplified in FIG. 10. In addition, the scroll bars B1001a and B1001b are displayed. In a case where the partial image is not to be displayed (N in Step S1301), the controller 400 determines whether or not to end the inspection (Step S1306).

The controller 400 that has displayed the partial image performs bright-or-dim display of the enlarged image of the abnormal image (Step S1303). The controller 400 performs the bright-or-dim display by setting the normal display state for the enlarged image of the abnormal image displayed in the displayed partial image and setting the dimmed-state display for the enlarged image of the abnormal image that is not displayed in the partial image.

The controller 400 determines whether or not the inspection result image has been scrolled by the scroll bars B1001a and B1001b (Step S1304). In a case where the inspection result image has been scrolled (Y in Step S1304), the controller 400 returns the process to the processing step of Step S1302 to display the partial image of the inspection result image in accordance with a scroll direction and a scroll amount. Further, the bright-or-dim display of the enlarged image of the abnormal image is performed.

In a case where the inspection result image has not been scrolled (N in Step S1304), the controller 400 determines whether or not to return the display of the area B801 to the normal inspection result display screen (Step S1305). For example, the controller 400 determines whether or not to return the inspection result display screen from the inspection result display screen of FIG. 9 or FIG. 10 to the normal inspection result display screen of FIG. 8. Whether or not to return the inspection result display screen to the normal screen is determined based on, for example, whether or not the user has changed the display ratio in the text box B812 of the inspection result display screen of FIG. 9 or FIG. 10 to 100%. In addition, a “back button” may be provided on the inspection result display screen of FIG. 9 or FIG. 10, and whether or not to return the inspection result display screen to the normal screen may be determined based on whether or not the “back button”has been pressed.

In a case where the inspection result display screen is to be returned to the normal inspection result display screen (Y in Step S1305), the controller 400 repeatedly performs the processing steps of Step S1301 and the subsequent steps. In a case where the inspection result display screen is not to be returned to the normal inspection result display screen (N in Step S1305), the controller 400 determines whether or not to end the inspection (Step S1306). Whether or not to end the inspection is determined based on whether or not the user has pressed the button B806 that is the inspection end button on the inspection result display screen of FIG. 9 or FIG. 10. After having confirmed the details such as the position of the abnormal image, the user presses the button B806 to end the work.

In a case where the inspection is to be ended (Y in Step S1306), the controller 400 ends the processing. In a case where the inspection is not to be ended (N in Step S1306), the controller 400 repeatedly performs the processing steps of Step S1305 and the subsequent steps.

In the above-mentioned example, the partial image and the enlarged image of the abnormal image are configured to be displayed on the same inspection result display screen. The present disclosure is not limited thereto, and the respective images may be configured to be displayed on different screens. Further, the enlarged image has been used as the related image corresponding to the abnormal image, but the present disclosure is not limited thereto.

As described above, the enlarged image of the abnormal image that is not displayed in the partial image of the inspection result image is displayed in a display state different from the normal display state. Therefore, a relationship between the partial image of the inspection result image displayed on the display and the abnormal image can be easily distinguished. The position of the abnormal image in the inspection result image can also be easily distinguished.

The inspection apparatus 500 may be provided as a stand-alone device independently of the image forming system 1. In this case, the inspection controller 510 of the inspection apparatus 500 is connected to the controller 400 so as to enable communication therebetween. The inspection apparatus 500 also includes the operating device including the display for displaying the inspection result display screen and the input interface for receiving input from the user. In the processing of FIG. 15, the inspection controller 510 (CPU 5001) executes the processing steps of Step S916 and Step S917 following the processing step of Step S913. The inspection controller 510 (CPU 5001) executes the processing of FIG. 16 to perform the display control of the inspection result display screen. In this case, the printed matter discharged from the printer 300 is manually supplied to the inspection apparatus 500 by the user.

The inspection apparatus 500 may also have an in-line configuration provided inside the printer 300. In this case, the first reader 5051a, the second reader 5051b, and the flow reading glasses 5053a and 5053b are provided downstream of the fixing device 308, and read the sheet to which the image has been fixed by the fixing device 308. The function of the inspection controller 510 is provided to the controller 400.

The image forming system 1 according to this embodiment is configured to display the inspection result display screen on the display of the operating device 200, but the inspection result display screen may be displayed on a display of another apparatus. For example, the inspection result display screen may be configured to be displayed on a display of an external apparatus such as a personal computer connected to the image forming system 1 through the communication I/F 4305 so as to enable communication therebetween.

In the above description, the display ratio displayed in the text box B812 is expressed by the ratio (scale ratio) of the image displayed in the area B801 to the entire image of the inspection result image set to be 100%. In another example, the display ratio displayed in the text box B812 may be expressed by an enlargement ratio of the inspection result image. The partial image of a part of the inspection result image enlarged in accordance with the enlargement ratio is displayed in the area B801.

In a case where the display ratio is expressed by the enlargement ratio, in the processing of FIG. 16, the controller 400 examines whether the display ratio in the text box B812 is set to a value greater than 100% (for example, 135%) in the processing step of Step S1301. Therefore, the controller 400 determines whether or not to display the partial image of the part of the inspection result image in an enlarged manner. In a case where the partial image is to be displayed (Y in Step S1301), the controller 400 displays the partial image of the inspection result image enlarged in accordance with the display ratio (Step S1302). Accordingly, the partial image of the inspection result image is displayed in an enlarged manner in the area B801.

### MODIFICATION EXAMPLE

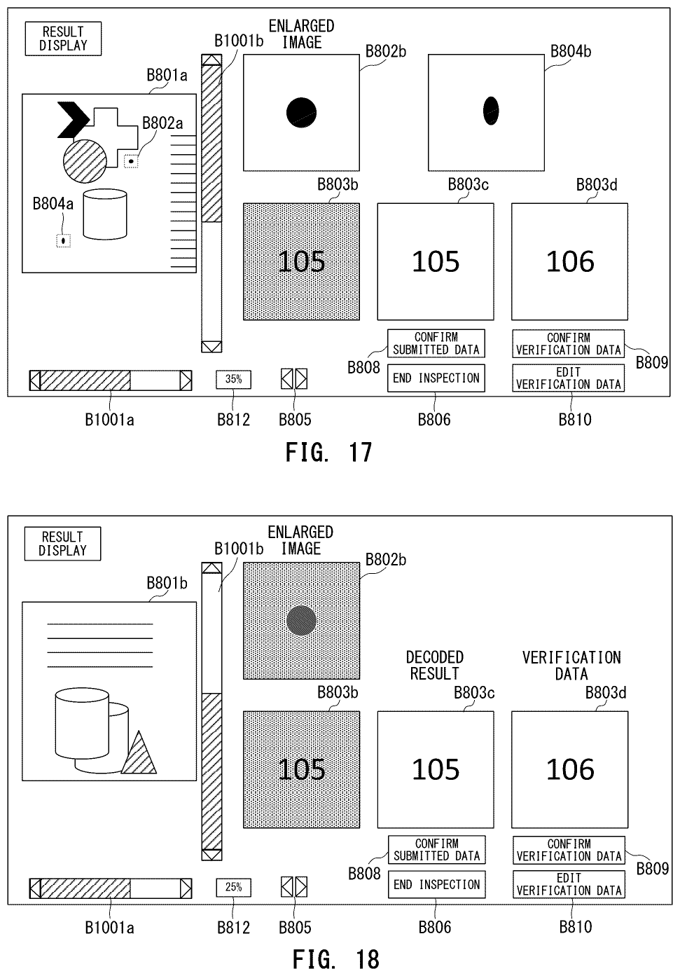

In the partial image of the inspection result image displayed in the area B801, a plurality of abnormal images may be displayed, or no abnormal image may be displayed. FIG. 17 is an exemplary view of the inspection result display screen obtained in a case where a plurality of abnormal images are displayed in the partial image. FIG. 18 is an exemplary view of the inspection result display screen obtained in a case where no abnormal image is displayed in the partial image.

In FIG. 17, an area B804a is added as an abnormal spot display area to the inspection result image of FIG. 8. The area B804a indicates the position of a third abnormal image in the entire image that has been determined to be abnormal by the inspection. The third abnormal image is an abnormal image in a region set as the “standard inspection area” or “focused inspection area” on the inspection setting screen of FIG. 5. An image B804b is an enlarged image of the area B804a.

In this manner, in a case where a plurality of abnormal images are displayed in the partial image, the enlarged images of the respective abnormal images are displayed. For the first abnormal image in the area B802a and the third abnormal image in the area B804a that are displayed in the partial image displayed in the area B801a, the image B802b and the image B804b that are the enlarged images are displayed in the same normal display state. For the second abnormal image in the area B803a that is not displayed in the partial image displayed in the area B801a, the image B803b that is the enlarged image is displayed in a dimmed state instead of being displayed in a normal display state.

In FIG. 18, the display ratio in the text box B812 is reduced, and the range of the enlarged partial image is narrower than in FIG. 10. In this case, the area B803a is not included in the area B801b, and no abnormal image is displayed in the partial image. Due to no abnormal image being displayed in the partial image, the image B802b and B803b that are the enlarged images are both displayed in a dimmed state instead of being displayed in a normal display state.

According to the present disclosure, the position of the abnormal image in the inspection result image can be easily distinguished.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of priority from Japanese Patent Applications No. 2024-133205, filed Aug. 8, 2024, and No. 2025-099619, filed Jun. 13, 2025, which are hereby incorporated by reference herein in their entirety.

What is claimed is:

1. An inspection apparatus comprising:
a reader configured to read a sheet on which an image has been formed;
an inspector configured to inspect a read image that has been read by the reader;
a display device configured to display a display screen including a first display region in which an entirety of the read image is displayable and a second display region in which a part of the read image is displayed in an enlarged manner; and
a controller configured to control the display device,
wherein the controller is configured to:
display, in a case where there is a first abnormal image in the read image inspected by the inspector, the read image in the first display region, and display the first abnormal image in an enlarged manner in the second display region; and
set a first display state for the second display region in a case where the first abnormal image is displayed in the first display region, and set a second display state different from the first display state for the second display region in a case where the first abnormal image is not displayed in the first display region.

2. The inspection apparatus according to claim 1, wherein the first abnormal image is displayed in a dimmer manner in the second display state than in the first display state.

3. The inspection apparatus according to claim 1, wherein the first display state and the second display state differ in color of a frame around the first abnormal image.

4. The inspection apparatus according to claim 1, wherein the first abnormal image is provided with a mark in the second display state.

5. The inspection apparatus according to claim 1, wherein the first abnormal image is displayed with a lower image density in the second display state than in the first display state.

6. The inspection apparatus according to claim 1, further comprising an operating device configured to perform enlargement and movement of the read image displayed in the first display region.

7. The inspection apparatus according to claim 1,
wherein the first abnormal image is displayed in the first display state, and
wherein the first abnormal image is not displayed in the second display state.

8. The inspection apparatus according to claim 1, wherein the second display state involves displaying a message indicating that the first abnormal image is not displayed in the first display region.

9. The inspection apparatus according to claim 8, wherein the message is displayed in a callout.

10. The inspection apparatus according to claim 8, wherein the message is displayed in a box connected by a leader line.

11. The inspection apparatus according to claim 1, wherein the controller is configured to perform switching so that the first abnormal image is displayed in the first display region in a case where the first abnormal image in the second display region is selected under a state in which the first abnormal image is not displayed in the first display region.

12. The inspection apparatus according to claim 1, wherein the controller is configured to perform switching so that the first abnormal image is displayed in an enlarged manner in the first display region in a case where the first abnormal image in the second display region is selected under a state in which the entirety of the read image is displayed in the first display region.

13. The inspection apparatus according to claim 1, wherein the inspection apparatus is configured to control, in a case where there is a plurality of the first abnormal images in the read image and the plurality of the first abnormal images are displayed in the second display region, each of the plurality of the first abnormal images that is displayed in the read image in the first display region to be displayed in the first display state, and each of the plurality of the first abnormal images that is not displayed in the read image in the first display region to be displayed in the second display state.

14. An image forming apparatus comprising:
an image former configured to form an image on a sheet; and
an inspection apparatus,
the inspection apparatus comprising:
a reader configured to read the sheet on which the image has been formed;
an inspector configured to inspect a read image that has been read by the reader;
a display device configured to display a display screen including a first display region in which an entirety of the read image is displayable and a second display region in which a part of the read image is displayed in an enlarged manner; and
a controller configured to control the display device,
wherein the controller is configured to:
display, in a case where there is a first abnormal image in the read image inspected by the inspector, the read image in the first display region, and display the first abnormal image in an enlarged manner in the second display region; and
set a first display state for the second display region in a case where the first abnormal image is displayed in the first display region, and set a second display state different from the first display state for the second display region in a case where the first abnormal image is not displayed in the first display region.

15. A display apparatus comprising:
a display device configured to display a display screen including a first display region in which an entirety of a read image is displayable and a second display region in which a part of the read image is displayed in an enlarged manner; and
a display controller configured to control the display device,
wherein the display device is controlled to display, in a case where there is a first abnormal image in the read image, the read image in the first display region, and display the first abnormal image in an enlarged manner in the second display region, and
wherein the second display region is set to a first display state in a case where the first abnormal image is displayed in the first display region, and the second display region is set to a second display state different from the first display state in a case where the first abnormal image is not displayed in the first display region.

16. The display apparatus according to claim 15, wherein the display apparatus is configured to control, in a case where there are a plurality of the first abnormal images in the read image and the plurality of the first abnormal images are displayed in the second display region, each of the plurality of the first abnormal images that is displayed in the read image in the first display region to be displayed in the first display state, and each of the plurality of the first abnormal images that is not displayed in the read image in the first display region to be displayed in the second display state.

17. The display apparatus according to claim 15, wherein the first abnormal image is displayed in a dimmer manner in the second display state than in the first display state.

18. The display apparatus according to claim 15, wherein the first display state and the second display state differ in color of a frame around the first abnormal image.

19. The display apparatus according to claim 15, wherein the first abnormal image is provided with a mark in the second display state.

20. The display apparatus according to claim 15, wherein the first abnormal image is displayed in the first display state without being displayed in the second display state.

21. The display apparatus according to claim 15, wherein the second display state involves displaying a message indicating that the first abnormal image is not displayed in the first display region.

22. The display apparatus according to claim 15, wherein the display controller is configured to perform switching so that the first abnormal image is displayed in the first display region in a case where the first abnormal image in the second display region is selected under a state in which the first abnormal image is not displayed in the first display region.

23. The display apparatus according to claim 15, wherein the display controller is configured to perform switching so that the first abnormal image is displayed in an enlarged manner in the first display region in a case where the first abnormal image in the second display region is selected under a state in which the entirety of the read image is displayed in the first display region.
